(19) United States
(12) Patent Application Publication
(10) Pub. No.: US 2003/0187932 A1
(43) Pub. Date: Oct. 2, 2003

(54) Network project development system and method

(76) Inventor: Bruce C. Kennedy, Torrance, CA (US)

Correspondence Address: CISLO & THOMAS, LLP, 233 WILSHIRE BLVD, SUITE 900, SANTA MONICA, CA, 90401-1211, US

(21) Appl. No.: 10/112,149

(22) Filed: Mar. 28, 2002

(51) Int. Cl. G06F 15/16

(52) U.S. Cl. 709/205

(57) ABSTRACT

A digital interactive dialogue system which acts as a catalyst on collaborative dialogues, allowing a moderator to more efficiently guide disparate teams of members or system users, brought together by a common project. The project structure limits the user's access to just the information to those authorized categories and likewise any information the user inputs is moderated by a moderator and distributed only to those other users having access to the category and/or sub-category the author was reviewing when he or she entered the information. The attention of these other users having access to the category will be diverted by the entered information only when they direct their attention to that category. Thus, the user authorization methods can be used to restrict access both for security purposes and for efficiency purposes. Each category within the system comprises both a content module and a points module. Within a given category, a moderator exclusively manages and controls the content in the content module, whereas the system users having access to the category freely submit points which are automatically distributed and held inviolate.

### COPYRIGHT PROTECTION OF DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

This invention relates generally to software-based management tools, and in particular to moderated group dialogues in a collaborative environment over a computer network.

In businesses as well as in governmental entities today, there is a need for ever more rapid, focused and contextual communications. There is also a need for a clear, permanent record of the exchanges that occurred, and all versions of all related documents that were developed, throughout the completion of a project. Many entities develop hardcopy files pertaining to a project and update these files as quickly as possible to maintain an almost real-time record of the communications that occur pertaining to the project. Conversely, some endeavor to use an unsecured, peer-to-peer e-mail-type process to endeavor to solve their group communications problems.

The difficulties with hardcopy files include the fact that they can be gravely out of date, important pages can be removed or lost, and the most current version of evolving working files can only be in one place at any given time. Additionally, mark-ups and comments also can at best be in only one place at any given time, and at worst, are often written on pages or inserts that are easily lost or removed from the important context in which they are written. Additionally, hardcopy files are inadequate in many instances because verbal communications do not always get reduced to writing, in part because formal and even informal intra-office memoranda can be time consuming. Limitations of an e-mail based process should also be raised: not a group dialogue, individual to individual, not secure, not contextual, not a leader-moderated dialogue, not useful to senior management seeking to keep an eye on multiple dialogues and e-mails can be “lost” when convenient, etc. That is, there is no central record of the various exchanges and documents, and thus no complete, contextual and cohesive history available for ease of oversight and accountability. Additionally, there is very little confirmation available in these dialogs and multiple dialogs. Once a comment is made, whether verbal or in writing, it is often unclear whether all intended recipients in fact heard or read the comment.

Various attempts have been made to facilitate such group dialogues through the use of computers and computer networks. The industry includes Enterprise Resource Planning (ERP) software programs, Customer Relations Management (CRM) programs, Sales Automation Programs (SAP), and e-mail based groupware, such as LotusNotes™. Each of these programs and interfaces, however, are different from the present invention and are directed to different applications. ERPs are typically directed at tying in third-party contacts to an enterprise. Likewise, CRMs and SAPs typically amount to a glorified contacts-type program. LotusNotes™ is a glorified e-mail system that fails to provide any method for moderated dialogs or for a sufficient record-keeping system. None of these applications address the need for a project-development type program that can be implemented over either a local-area or a global computer network.

What is needed is a computer network-based communications interface and method that facilitates moderated dialogues and the rapid, secure communication of information, ideas, and proposals, and maintains inviolate each communication for the purposes of accountability and managerial oversight. Additionally what is needed is such a system and method that can maintain a record of each communication within the context in which it was created.

### BRIEF SUMMARY OF THE INVENTION

An object of the present invention is to provide a server-based moderated collaborative environment management tool that uses pre-existing client-side hardware/software combinations and is easy to use. Another object of the present invention is to provide such a management tool that does not require any client-side software other than a standard web browser and a connection to a standard network, depending on the application.

A further object of the present invention is to provide a management tool that is platform-independent for users and that can be configured to provide many levels of security. Adaptable to virtually all business environments, including business, government and venture environments requiring the highest levels of security.

A further object of the present invention is to provide a means to organize and preserve a complete, contextual historical record of all comments, points-of-view and all versions of all related documents which have gone into the development of projects in single, cohesive and permanent archive.

These objects are accomplished by the present invention of a server-based collaborative environment management tool that acts as a catalyst to the type of group interchanges essential to most business and governmental tasks. Such a system, which may be available in both ASP (Application Service Provider) and stand-alone versions, manages all sorts of group dialogues from the most hyper-secure, internal exchanges of the technologically elite to entirely wide-open, public dialogues available to anyone who has access to even the most basic technology, and almost everything in between these two extremes.

Other aspects and advantages of the present invention will become readily apparent to those skilled in the art from the following detailed descriptions of preferred embodiments when considered in conjunction with accompanying drawings, which illustrate, by way of example, the principles of the invention.

### BRIEF DESCRIPTION OF THE DRAWINGS

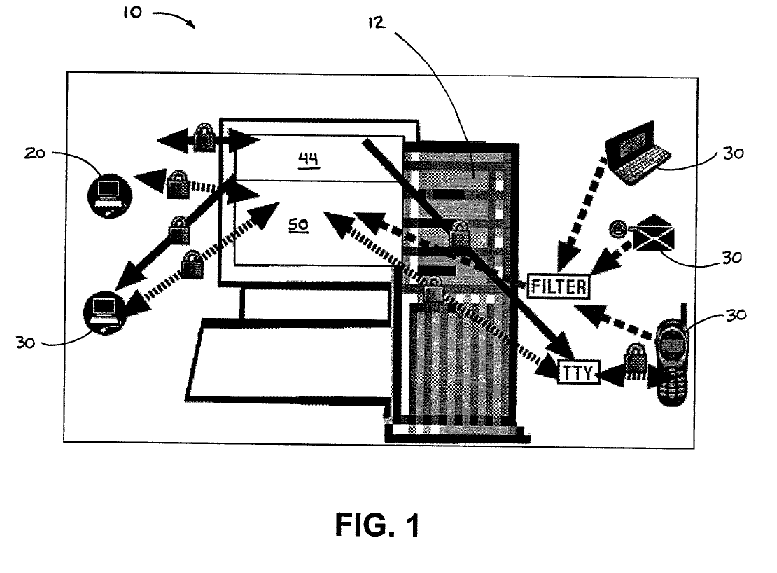

FIG. 1 is a diagram of one embodiment of the present invention.

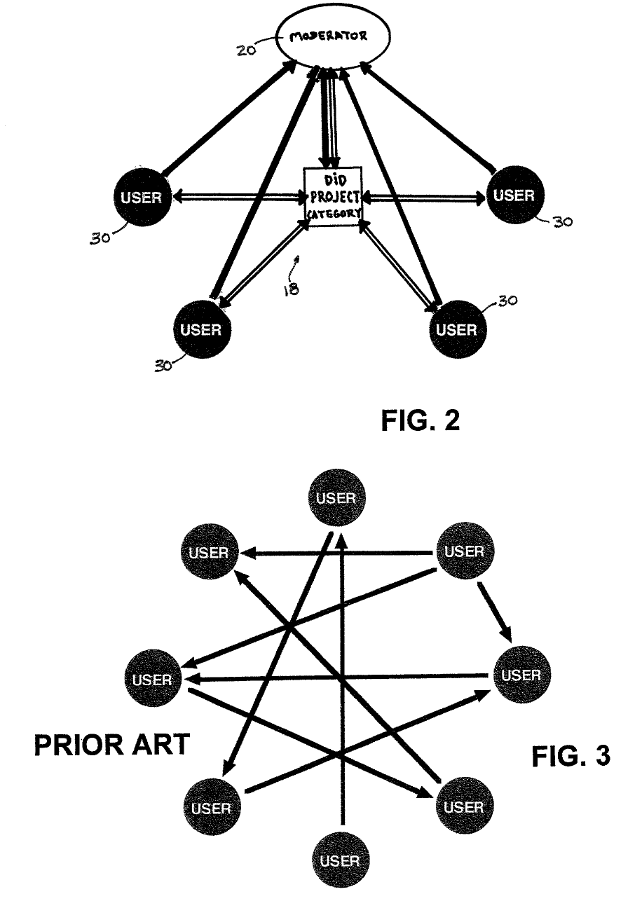

FIG. 2 is a diagram of the moderated and centralized flow of information in one embodiment of the present invention.

FIG. 3 is a diagram of a standard email message system.

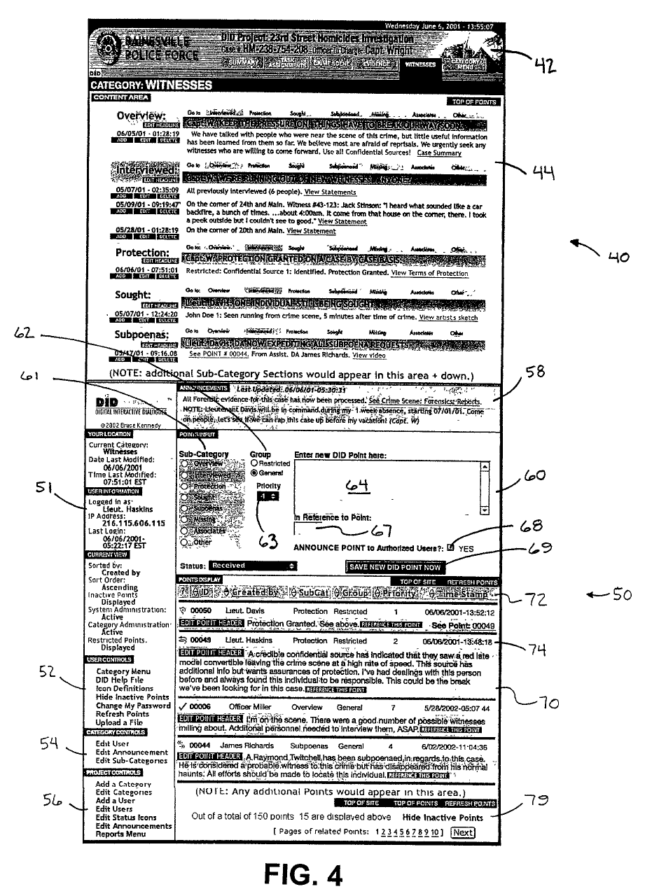

FIG. 4 is a diagram of a computer screen display in keeping with one embodiment of the present invention.

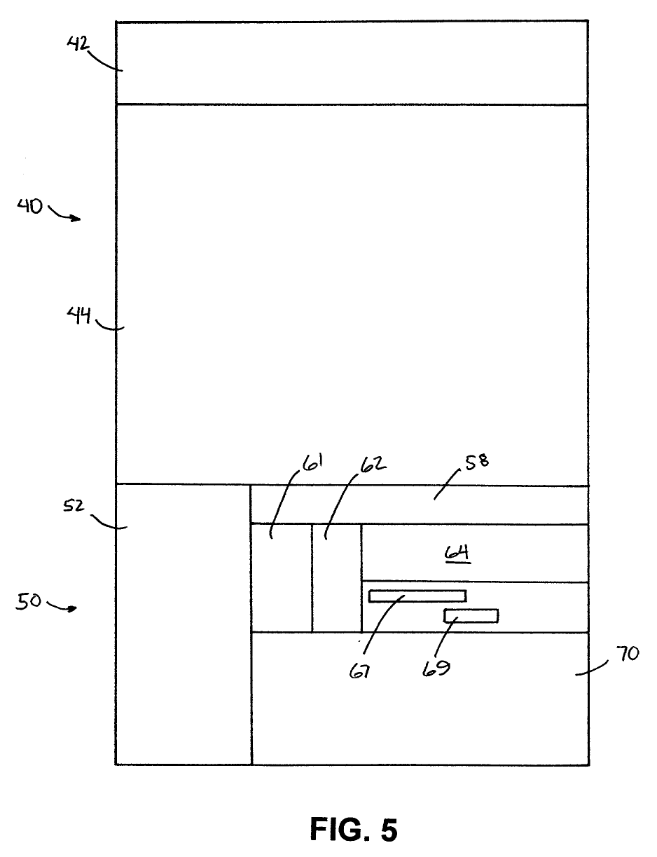

FIG. 5 is a diagram of the basic components in a computer screen display in keeping with one embodiment of the present invention.

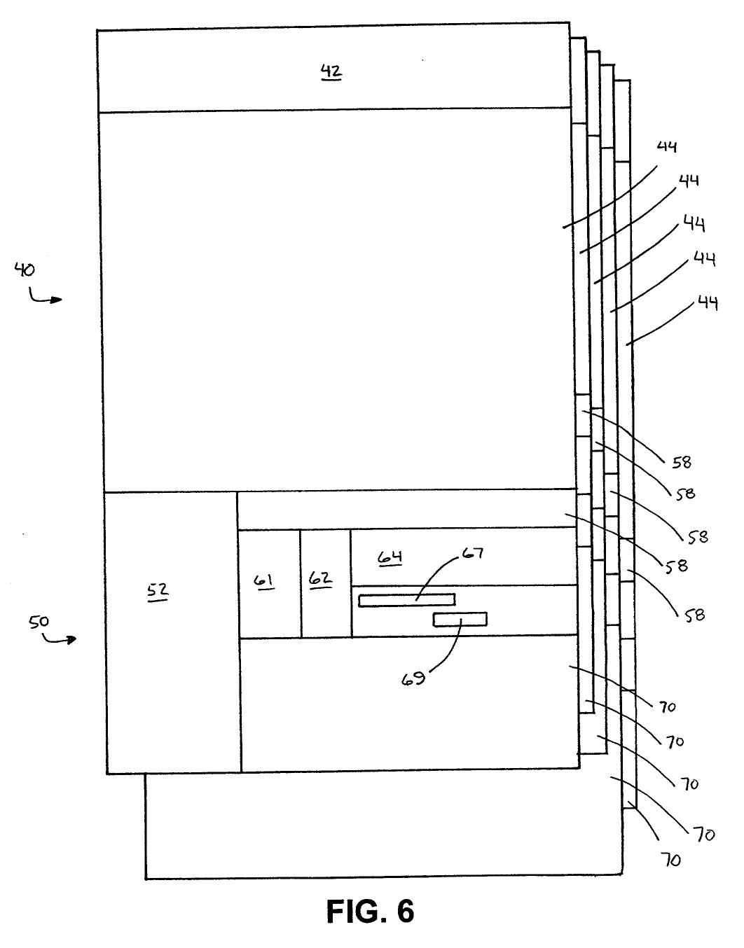

FIG. 6 is a diagram of more specific components in a computer screen display in keeping with one embodiment of the present invention.

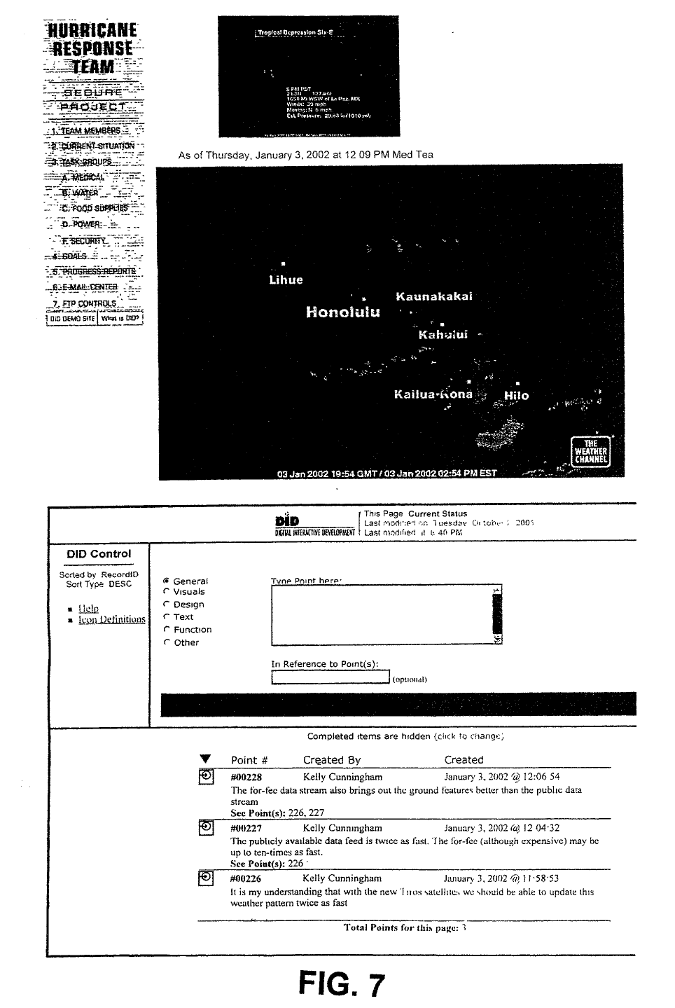

FIG. 7 is a diagram of a computer screen display in keeping with another embodiment of the present invention displaying three Points pertaining to the “Current Status” Category.

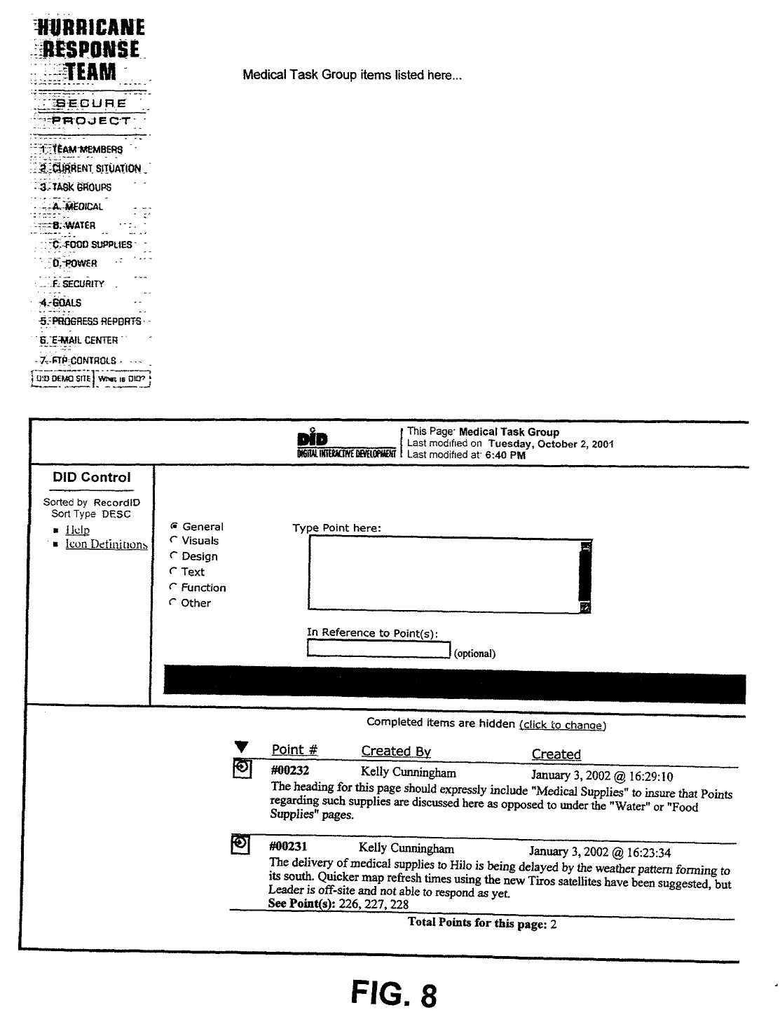

FIG. 8 is a diagram of a computer screen display in keeping with the embodiment of FIG. 7 displaying two Points pertaining to the “Medical” Category.

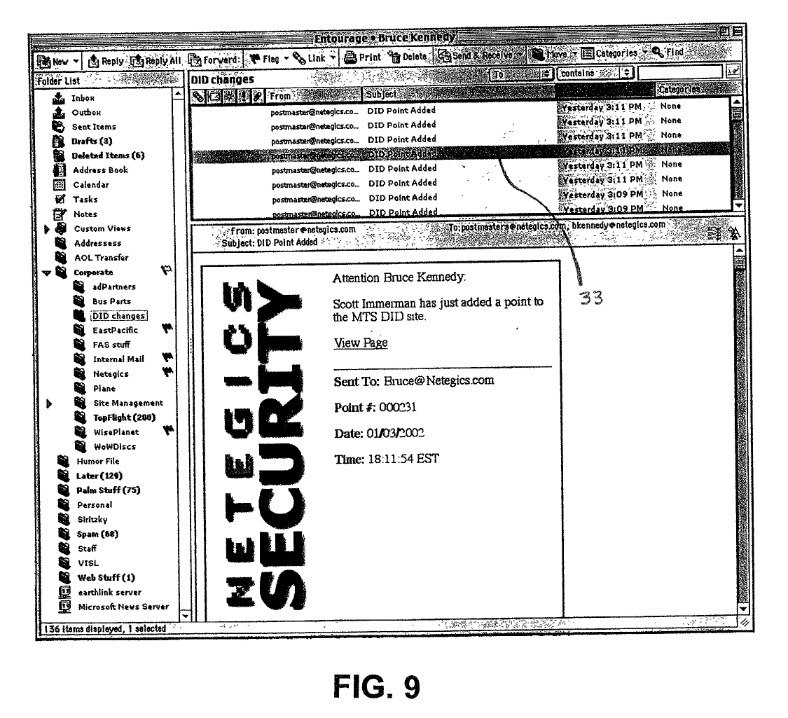

FIG. 9 is a diagram of a computer screen display in keeping with this embodiment displaying an email message that accompanies an urgent DiD Point.

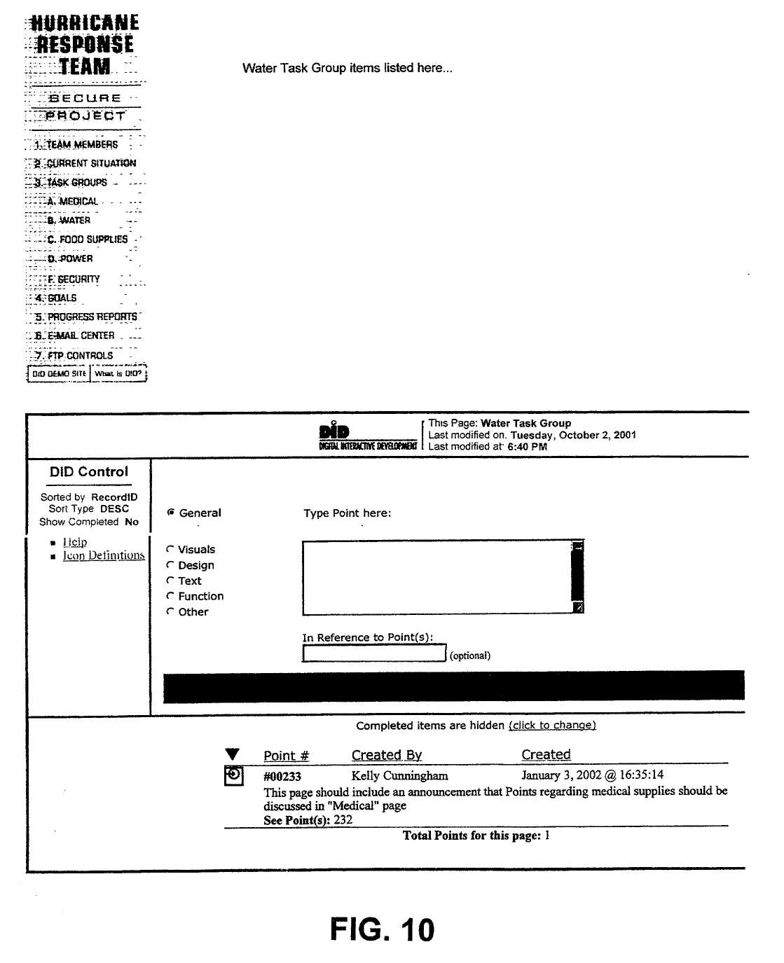

FIG. 10 is a diagram of a computer screen display in keeping with this embodiment displaying a Point pertaining to the “Water” Category.

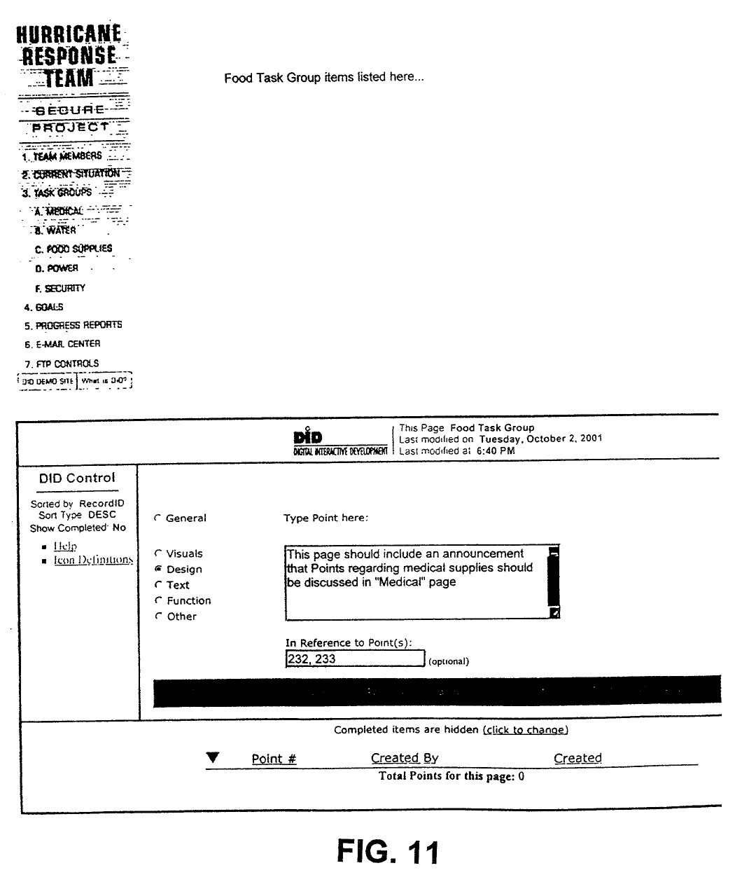

FIG. 11 is a diagram of a computer screen display in keeping with this embodiment displaying a Point not yet saved pertaining to the “Food” Category and referencing two other Points.

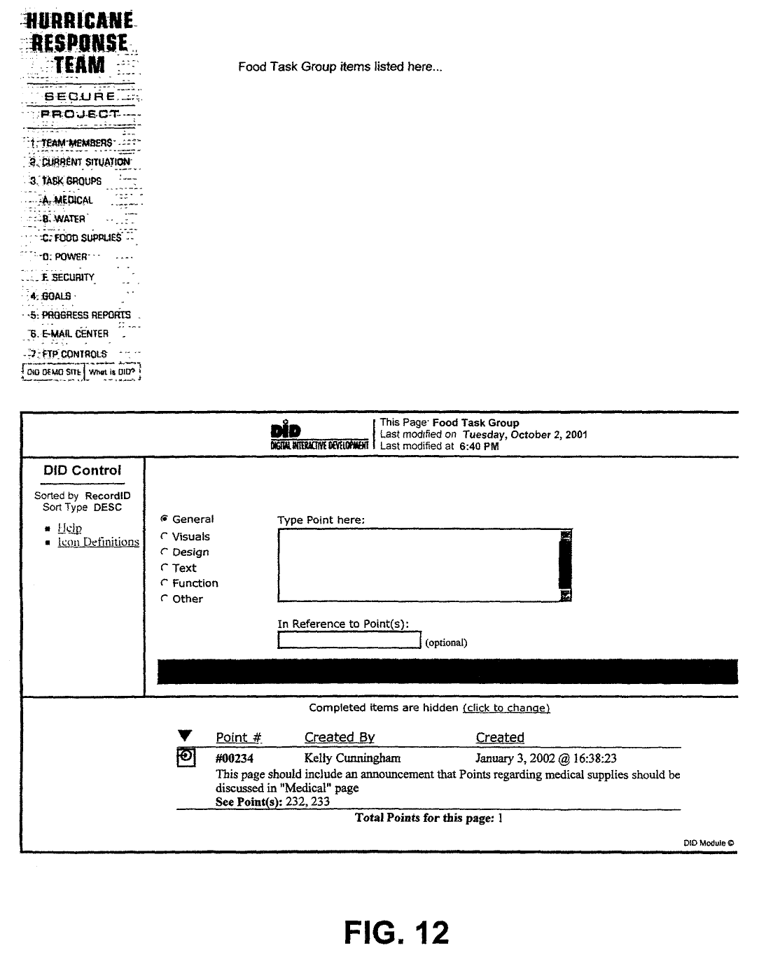

FIG. 12 is a diagram of a computer screen display in keeping with this embodiment displaying the Point of FIG. 11 once saved.

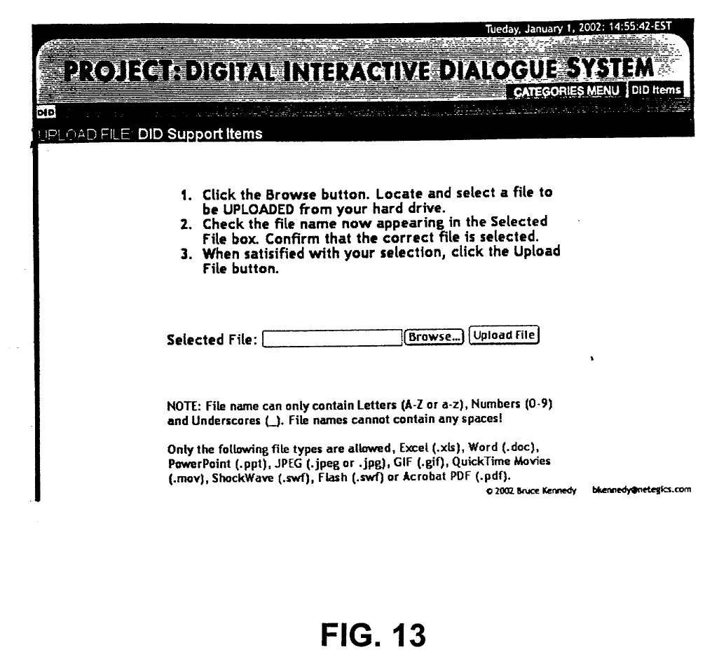

FIG. 13 is a diagram of a computer screen display in keeping with the present invention showing a window for selecting an Upload file..

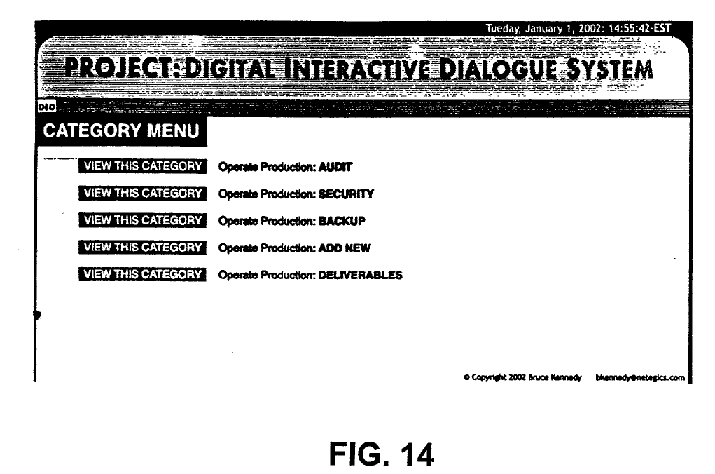

FIG. 14 is a diagram of a computer screen display in keeping with the present invention displaying a Category Menu.

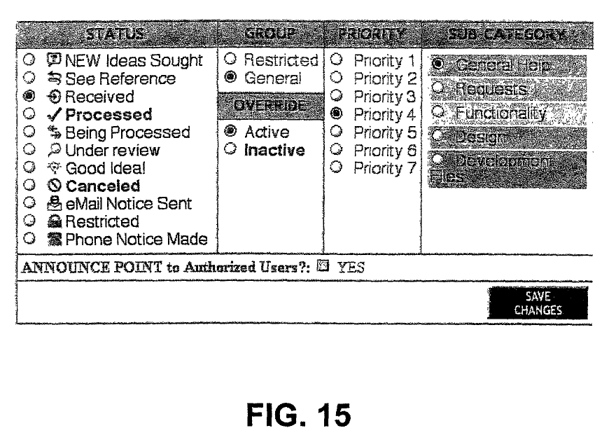

FIG. 15 is a diagram of a computer screen display in keeping with the present invention displaying a menu of several Status icons.

### DETAILED DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

A DiD (Digital Interactive Dialogue) system is an ASP-type (Application Service Provider) process which acts as a catalyst on collaborative dialogues, allowing leaders to more efficiently guide disparate groups of people, brought together by common interests, through a focused search for informed decisions and solutions.

One preferred embodiment of the present invention is easy to use, and requires minimal hardware or software, typically requiring no client-side software other than a standard, commercially-available web browser and access to a network. This embodiment of the present invention also is platform independent for users and can be configured to provide many levels of security. Authorization methods can be used to restrict access for everything from the most specific bit of information to the broadest areas of data; from a single User comment (referred to herein as a “Point,” short for the User's point of view) to the entire site.

Definitions

A “DiD System” is any Collaborative Environment information management installation which relies on any DiD module for its functionality and usefulness.

A “Point” is a comment which is stored in a database by a User. A Point stored in context to the Category under which it was created, as described below. It may be text only, it may reference one or more other Points using other Point's ID/Reference Numbers. A Point has the following properties: the Point text, a Category, a Sub-category, a Group (such as general or restricted), a Priority indication, a Status (such as “in development,” “completed,” “cancelled,” etc.), information denoting it as Active or Inactive, a reference number, an author or username (i.e., the User that created it), a date and time stamp of creation, an IP address of the device used to enter the Point, the method of entry (such as the URL of the page, the phone number, the email address or other ID), and optionally, reference information for referencing one or more existing Points, and optionally file information (i.e., requesting one of adequate authority to display for use by other Members or Users of the Team an uploaded and/or outside file, data, or server and pointer information pertaining to that uploaded and/or outside file, data, or server).

A “Project Administrator” or just “Administrator” is an individual or department of individuals who has been assigned a password and has access to the system, has control of all setup choices and preferences, can view all Points, has access to all Categories, modify all Header Information for each Point which can be edited and control of all Content areas. The Project Administrator's object has the following properties: a full name, a unique ID, identifying information, identification methods allowed (text password, voice print, fingerprint, cardkey, etc.), last login information, an active date, an inactive date and preferences. “Category Administrators” or “Sub-Category Administrators” are similar to a Project Administrator but only have Administrator privileges for specific Category(ies) and/or Sub-Category(ies), respectively.

Depending on the scale of the DiD System, there may also be Leaders or Moderators separate and apart from the Administrator. “Project Leaders” or “Project Moderators” are the decision makers and moderators of the Dialogue of project. In smaller installations the Moderators may double as the Administrators. In larger set-ups they may be different people. Depending on the organizational structure of the entity utilizing the DiD System, a Leader or Moderator may be superior to the Administrator, may be subordinate to the Administrator, or may be of equal or unrelated status with respect to the Administrator. A Project Moderator may create one or more “Category Moderators” and even “Sub-Category Moderators.” This allows work load and disciplines to be separated. It can also allows for checks and balances in the management and security improvements of the DiD System.

A “User” is an individual who has been assigned a username and password and has access to a predetermined portion of the DiD system, either one or more Categories or one or more Sub-Categories. A User can view content within these predetermined Categories or Sub-Categories as well as saved Points pertaining to the same, and can prepare, and submit Points and Upload files for review within these Categories or Sub-Categories. A User can also set preferences and change the password for him or herself, and can initially designate a Sub-Category and Group to a given Point. A user object has the same set of properties as an administrator.

An “Upload file” is a word processor document, a spreadsheet, a JPEG or GIF file, a PowerPoint file, an animated file, or other similar computer file that is selected by a User to be Uploaded to the system.

“Versions” or “Versioning” is the process by which an file, which may have originally been Uploaded by a User or Moderator, is maintained inviolate and unalterable. The Version may be made available on the system to be reviewed by other Users within a given Category or Sub-Category, and one or more of these Users may be allowed to download the version, make edits to the version, and submit the edited file as an Upload file. The edited Upload file, however, would not replace the original version. Rather, if the Moderator elects to make the edited Upload file available to other Users on the system, the DiD system automatically numbers the Upload file in sequence of its submission, such as “Public Document ver. 2.1” or the like. Whether made available to other Users or not, each Upload file is held inviolate by the DiD system. Versioning refers to this inviolate nature of Upload files and original versions, along with the automatic sequential number method of edited versions.

A “Guest” is not previously known to a nonsecure-access system before entry, and an “Observer” may observe all aspects of the Dialog and input Points, but may not control any aspects of a system. Anyone with the proper Access Privileges and a network capable computer or other communication device, may submit Points into the system through such outside means as e-mail messages or telephone messages to an Administrator, such as through a personal digital assistant or a teletypewriter. Additionally, limited only by the technical capabilities of these other means of system interaction, authorized Users may also access and use the other aspects and functions of a system through these alternate means.

One configuration for a public DiD system would be to allow the public to enter Points into a system by way of e-mails which will be noted as such and automatically entered into a secure Dialogue. This could be useful for legislative and or Regulatory mark up. These people could be responding to a public announcement asking for response. Their e-mails as they enter the System are not secure. Another public configuration could be to a community meeting place type environment. Users might need to identify themselves as members of some involved constituency (registered voters, residence within a geographic area, etc.) before entering Points.

A “Team” is a collection of individual Users and one or more Category Moderators (one or more of whom may also be acting as the Administrator), each having access to the DiD system. Each Team member is a member of one or more Categories. A “Category Moderator” is responsible for the information in the Content area, including any Sub-Category Summaries, any Announcements, and any documents, files and links made available for downloading or viewing. Additionally responsible for editing those parts of each Points Header Information which can be modified. This is the means by which the leaders actually moderate and lead the group. An Administrator is responsible for the actual operation, modifications, updates, etc. of the Content and Points modules. A Team Moderator and an Administrator can be the same individual.

Individual Points may also be assigned to a Group such as “Restricted” or “General.” Points designated as “Restricted” may be viewed only by Moderators, Administrators, upper management, company officials, or other Users given “Restricted” access by the relevant Moderators; whereas Points designated as “General” may be viewed by all Users having the appropriate access as described below. The Moderator, sometimes in combination with the relevant Administrator, may define other Groups, as well as the level of access needed to view Points designated as such newly defined Group. Only the Administrator or Moderator may change a Point's Group assignment.

A “Status” is an adjustable collection of descriptive titles and graphic icons. The Administrator assigns each Point a specific Status to denote its present state within the Dialogue; i.e. received, working, good idea, completed, etc. The Status provides indicia for one or more connected graphic icons for denotation in the “Points Display” area. For example, FIG. 15 illustrates a set of icons used in connection with the Status in one embodiment of the present invention (e.g., a Dialog for the development of a website). A “Priority” is an indicator, typically numerical, of the importance or urgency of a particular Point. The Moderator or Administrator may assign a Priority designation to a Point and may change the Priority designation at his or her discretion. In some instances, a change in a Priority designation may correspond with a change in the Status designation or with other changed circumstances within or outside the Dialogue.

A “DiD Project” is any group activity that is conducted using any DiD System or any DiD Module. A DiD Project is the environment in which a DiD System takes place. “DiD System” is the interactive process of comments, document Uploading, versioning, reaction and interaction conducted using a DiD Module. Within a DiD System, the directives, summaries, announcements, and the like presented by the Moderator is considered part of a Dialogue as well. All versions of Attachments available for Download and links to other bodies of data or servers submitted into a DiD System are considered part of a Dialogue.

A “Category” is a collection of information, within a DiD System or Module, which is interrelated. A Category is typically the largest unit for dividing up a project, within a DiD System or Module, and often takes the form of one or more web browser content pages related to one subject, as defined by the Project Moderator. In one embodiment of the present invention, all Categories of the DiD System in effect corresponds to a single web page, drawing data from multiple databases. This embodiment makes the DiD System more secure and expedites the design, the display, and the updating of the content since the URL addresses are not passed back and forth.

A “Sub-Category” is a subdivision of within a Category, and each Category can have several Sub-Categories. Each Sub-Category can itself contain several further subdivisions typically called Summaries. For ease of reference, both Sub-Categories and subdivisions within a Sub-Category will be referred to herein as Sub-Categories. The Sub-Categories are typically based on different types or themes of information within the Category. Each Point is assigned to a specific Category, but also may be further assigned a Sub-Category designation. Only one Sub-Category can be assigned to any one Point. The Sub-Category designation, therefore, may be used to sort or filter Points within a Category.

Moderators/Administrator can at their discretion change the Sub-Category denotation of a Point. That is, the Sub-Category designation of a Point is not maintained inviolate, but rather may be changed to place the Point in a better context in the opinion of the Moderator or Administrator. Doing so causes the automatic creation of a new Point in the original Sub-Category context and indicating the Sub-Category change. This allows Users expecting to find a Point within a specific Sub-Category context to find it by sorting by the new Sub-Category classification.

For easy denotation of Sub-Categories in the “Points Display” area, and for ease of reference in any related Content Area, each may be assigned a specific unique background color. The Category Moderator also develops various Summaries for each Sub-Category. The Summary is typically sentences, sentence fragment, an inline image, and/or a link summarizing the status of some aspect of a Sub-Category (and is provided in series with the Summaries of the other Sub-Categories within this current Category at the top of the Content Page).

Referring now to the drawings, FIGS. 1 and 2 show in diagram form the communication and organizational structure of a system in keeping with the present invention. In contrast to FIG. 3, which is a standard email environment, the present invention contemplates a highly moderated and contextual dialog. The dialog is moderated and contextual in several ways. A Project Leader or Moderator 20, in connection with a Project Administrator, creates and updates the content in the Content Area 44, posts Announcements in the Announcement Area 58, and establishes one or more Categories into which the project is divided. Each Member or User 30 then has access to only those Categories that the Moderator and Administrator determine are most relevant to that User's intended contribution to the dialog.

As illustrated in FIGS. 4 through 13, the dialog proceeds by allowing and encouraging Users to input Points, short for “points of view.” Each Point is intended to be relevant to the Category the User 30 was reviewing at the time, and the Point once saved is displayed only to each other User 30 that has access to that particular Category and only when such other User 30 turns his or her attention to reviewing that Category. That is, the Point does not interfere with the User's work until the User turns to the context in which the Point was authored. As a result, the Point is highly contextual and this context is implied and understood as a result of present invention. The author does not have to reiterate the context, but rather can quickly further specify the context in detail by identifying the Sub-Category through a convenient list of Radio Buttons 61 near the Points Entry window 64.

FIGS. 1 and 2 schematically illustrate the communication paths anticipated by an embodiment of the present invention, showing that much of the dialog is moderated by a Leader or Moderator 20. In FIG. 1, the solid lines show a two-way communication path between the Moderator 20 and the Content Area 44, and a one-way communication path between the Content Area 44 and each authorized User 30. The dashed lines show the two-way communication paths between each authorized User 30 and the Points Module 50. That is, while the Content Area 44 (as well as the Announcements Area 58, discussed below) is controlled exclusively by the Moderator 20, the Points Module received and distributes Points contributed by any authorized User 30, as discussed further below.

In addition to determining what the Content Area 44 and the Announcement Area 58 will display, and determining which Users 30 will have access to which Categories, the Moderator 20 also oversees the dialog and the Points from each user, especially when a User submits an Upload file, such as a text file, spreadsheet or static or animated graphics document. At such times, the Moderator will intercede and determine whether the upload will be included in the Content Area 44, such as in a Summary or the like, which will then be available for Download by the other Users 30 who are authorized to view a given Category.

For example, as shown in FIG. 2, a User 30 may view the content of a relevant Category 18 and may submit Points that are immediately distributed to other Users 30 that have proper access to this Category 18. This communication path is indicated by the hollow two-way arrow between each User and Category 18, as well as between the Moderator 20 and the Category 18. The User 30 may also submit Upload Files to the system, but the Moderator determines what Upload Files are included in the Content Area 44 or Announcements Area 58 corresponding to this Category 18, and thereby distributed to the other Users that have access to this Category. This latter moderated communication path is illustrated by the solid one-way arrow each User 30 and the Moderator 20, and by the solid double arrow between the Moderator 20 and the Category 18—since the Moderator 20 may both Download and Upload files to the Content Area 44 or Announcements Area 58 of the Category.

Methods for managing various versions of working documents are also provided, as discussed below. The Moderator also oversees various other aspects of a Point, including the Sub-Category designation, Status and the Group designation, which are initially selected by the Author of the Point. Moderators may also “grade” his or her view of each Point's urgency by assigning, and over time, revising a Priority designation. In these ways, the present invention is believed to be significantly different than any other interactive computer network based dialog model available today.

FIG. 4 shows the interface of one such embodiment of the present invention. In particular, FIG. 4 is a graphic enlargement from a DiD System interface showing a Standard Content Module 40 and a DiD Points Module 50. (Other Content Modules currently available include a Web page Module, a Web Site Module and a User Survey and Tabulation Module.) It shows a view of many of the controls that would typically be available to Users 30 with Moderator and Administrator privileges (and their support staffs) only. This is evidenced by certain control options shown that are typically available to only an Administrator or Moderator 20 having the necessary access to perform these Administrator-type functions, namely the Category Controls 54, the Project Controls 56, the Edit Headline, Add/Edit/Delete Summary, and Edit Point Header Controls. Other, non-Administrator Users 30 do not ordinarily have access to these controls.

Upper Content Area 42 comprises, the web site's logo and/or name, one or more navigational control buttons, and the current time, based on a predetermined time zone. All postings within a DiD System can be considered in relationship to this time, regardless of which time zone a viewing User 30 may actually be located. The actual number and names of the Control buttons depends on the particular installation's needs and may correspond to the different Categories within the DiD Project or in more complex installations provide a Category Menu button to lead Users to a list of available Categories, as shown in FIG. 14. The Categories actually established for a DiD System installation are at the discretion of those responsible for its management. In most cases this would be the Project Moderator, and he or she can establish a virtually unlimited number of Categories. Only those Categories to which a User has access will appear in the Upper Content Area 42 or Category Menu for that User.

Content Area 44 can be as large or as small as needed in order to accommodate the amount of content to be displayed with respect to that Category and/or Sub-Categories. FIG. 4 shows an embodiment of the present invention, but with the Content Area 44 foreshortened for the sake of illustration so that the Content Module 40 and the DiD Points Module 50 can be shown in a single drawing. In the embodiment shown in FIG. 4, a single scroll bar allows the User to move from the Upper Content Area 42 down to the bottom of the Points Module 50. Buttons, such as “Top of Site,” “Top of Points,” etc. are also provided for quick navigation between the various areas of a system. It is also contemplated within the present invention, however, that separate scroll bars could be utilized, one to scroll through the Content Area 44, another to scroll through the Points Module 50, and others to scroll through other screen areas or windows, independently from one another. These methods for increasing a Content Area to accommodate additional content and scrolling such content, whether in several separate windows or a single large window, are common to nearly all modern computer operating systems.

Content Area 44 usually contains other navigational tools to quickly go to the various Category areas and any related files, such as Sub-Category headings and summaries. The Sub-Categories are dependant on the needs of the particular DiD System project. The embodiment shown in FIG. 4 illustrates a view of a Category named “Witnesses” which includes Sub-Categories of “Overview,” “Interviewed,” “Protection,” “Sought,” etc., but may alternatively include any number of other relevant titles according to the particular application. For example, the embodiment shown in FIG. 7 contains Sub-Categories entitled “Team Members,” “Current Situation,” “Task Groups,” “Medical Task Group,” etc. as a result of the particular project being addressed in FIG. 7, as discussed in more detail below. The titles are pre-determined by the Administrator or Team Moderator and may be changed or added to during a project if such a need should arise. In the case of a very large number of Categories a “Category Menu” button would take Users to a Category Menu screen in which all categories available to them, depending on authorization, would be listed in a scrolling screen. There is no actual limit to the number of Categories which could be displayed in this way. FIG. 14 illustrates such a Category Menu screen showing five Categories to which the User has access, although the present invention contemplates projects where any number of other Categories would be involved.

DiD Logo Area displays the client trade name and information, such as a link to the “www.netegics.com” web site. Location Information Area 4 automatically notes in which Category the viewer is currently located. A notice as to when the Content area was last updated may also be automatically posted here by the DiD Server. Announcements Area 58 may contain any general announcements the Project and or Category Moderator deems to be of importance. The Moderator can limit the access to Announcements based on Category, Team, or Group, etc. designations, thereby directing the Announcements to only those Users having the relevant access.

User Information Area 51 displays some of the collected and stored information about the current user. Current View Area displays information on the current view settings. The User Controls Area 52 allows general Users to among other things get help, Upload files and set their preferences. If a User has the proper Authorization, various Administration controls will also be visible here, such as those shown in FIG. 4. Certain controls are viewable and controllable by Administrators or Moderators only, and are normally displayed in a distinct color so that they will be easily recognizable as Administrator Controls.

The DiD Points Entry Box 64 is where Users actually enter Points into a DiD System, i.e., comments, reviews, analysis, objections, related information, etc. The information entered and saved in the DiD System from here is available to be displayed in the Points Display Area 70 below. Sub-Category Radio Buttons 61 and Groups Radio Buttons 62 may be assigned by users to a Point they are about to Save into a DiD System, for consideration by other Users. This information will appear attached to their Point, when displayed in the Points Display Area 70.

The In Reference to Point Entry Box 67 is an area in which the User has the option of expressly referencing another, previously submitted Point, which he or she feels is relevant to the new Point being entered into the DiD System. An “Announce Point to Authorized Users” option 68 may also be available in this area. This will cause an e-mail, containing no secure information, to be sent to authorized Users containing a link which will automatically take Users to the new Point as well as its context within the DiD system. Once the Point is composed and ready to enter, the User clicks on the “Save New DiD Point Now” button 69 and the Point is entered.

Column Header 72 allows a User to sort all revealed Points by the content of specific columns simply by clicking on any column header. Ascending and descending sort orders are supported. In this way, a User can quickly browse through Points Ordered by ID Number, Author, Sub-Category, Group, Priority or Time. For example, in FIG. 4, the four Points being displayed have been sorted alphabetically by Author. This is indicated in this embodiment by the color or brightness of the arrow indicia in Column Header 72 for the “Created by” column.

Points Information Header 74 displays header information that is attached to and part of each Point. From left to right, the Points Information Header 74 comprises a Status Icon, (indicating any response by management in processing the Point), the Point Number (automatically generated by DiD server), the Author of the Point (automatically generated by DiD server), the Sub-Category Indicator and a Group Indicator (initially designated by the User and may be redesignated by the Administrator or Moderator), Priority Level for the Point (controlled by the Administrator or Moderator), and a Time and Date stamp (automatically generated by the DiD Server marking the moment it is received according to a predetermined time zone).

The content of all Points are displayed in the Points Display Area 70, along with any associated Reference Point's Point Number 76 (if included by User). This area expands downward, as needed, and is controlled by either the same scroll bar as used for the Content Area or a separate scroll bars at the right just for the Points Display Area 70, as discussed above. If the User has the proper Administrator-type authorization, this area would also display a “Edit Point Header” button, as illustrated in FIG. 4. Selecting this allows for the changing of the Status, Sub-Category, Group and Priority indicators, as well as identifying whether the Point is to be treated as Active or Inactive. With this edit feature, the Administrator and/or Moderator also has the option to Announce the Point by a standard email message 33 to all authorized Users if so desired.

Points Recap Area 79 displays the total number of all Points currently saved to this Category and the total number actually being displayed at a given time, depending on which User filters are in use. This allows Users to hide or display Inactive points thus reducing the number of Points visible. This technique is useful in complex dialogues with a great many Points to view. Since displaying all Points at once in a complex Dialogue with a great many Points can noticeably slow down the User's interface to the DiD System, a limit of the number of Points displayed “per page,” is also provided. It is believed that fifteen or less DiD Points provides a sufficiently fast User interface response on most typical computer terminals. Displaying Points in excess of fifteen at any one time may have a tendency to negatively effect the interface response times, depending on the hardware and operating system being utilized by the User.

Thus, the basic components of this embodiment of the present invention are illustrated in FIGS. 4 through 6. In this embodiment, a project is topically or functionally divided into one or more Categories. For each Category, there is a unique Content Module 40 and a Points Module 50. The Content Module 40 comprises an Upper Content Area 42 and a Content Area 44. The Points Module 50 comprises a User Information and Controls Area 52, an Announcements Area 58, a Points Entry Window 64, and a Points Display Area 70. More specifically, the Points Input Area 64 further comprises several radio buttons for the author to select from, including a list of Sub-Categories 61 and a list of Groups 62, an “In Reference to Point” Window 67, an option 68 to Announce the Point via email message to other similarly authorized Users, and a Save button 69; whereas the Points Display Area 70 further comprises a Column Header 72, Points Information Header 74, a “Reference this Point” button, 74 and Points Recap Area 79.

FIG. 6 illustrates schematically how a given DiD Project comprises several Content Modules 40 (comprising the Upper Content Area 42 and the Content Area 44) typically differentiated according Category based on topic or function, in which each Contents Module 40 is paired with a distinct Points Module 50 (comprising, inter alia, the Announcements Area 58, the Points Input Area 64, and a Points Display Area 70). As shown in FIG. 6, each Content Area 44 and Points Display Area 70 are unique to each Category and thus may differ in length from the Content Areas 44, Announcements Area 58, and Points Display Areas 70 of other Categories, as is common with a typical project where certain Categories (i.e., tasks, topics, functions, etc.) are more involved than other Categories.

An example of the operation of one embodiment of the present invention is illustrated in FIGS. 7 through 13. The project in FIGS. 7 through 13 was created for illustrative purposes only, and is not a real project. The DiD Project was to quickly develop a hurricane response monitoring system for a municipality of the State of Hawaii. In this embodiment, each Category corresponds more or less to a separate page of the eventual monitoring system layout. These include “Current Situation,” “Medical,” “Food Supplies,” etc. (The Sub-Categories include “General,” “Visuals,” “Design,” etc.) Medical personnel and supplies vendors may ultimately have access to only the “Medical” Category. The content that is to be displayed in the Content Area 44 is determined by the Project Moderator, or the content page(s) for specific Categories may be delegated to the relevant Category Moderators. This content is displayed in discrete pages, which are categorized according to the Categories.

Typically, in operation, a User logs onto the DiD System using his or her User ID and password. (More secure systems may require more rigorous forms of Authentication. Any known means of Authentication may be used with a DiD System.) The System recognizes the User and defines the access limitations for each User according to these initial entries, which are set by the Moderator. When the Category “Current Situation” is selected in the example in FIG. 7, the Content Area 44 displays a weather map, which is drawn from a remote server. A Points Module 50 is appended to each page of content such that a User who has access to a particular page or Category of content may scroll down to reveal the Points Module 50 for that Category of content. Each Points Module 50 is unique to the Category to which it is appended, and thus the Points entered and the Points displayed in each Points Module 50, as well as the Announcements displayed in the Announcements Area 58, are unique to the Category and are thus within the specific contextual setting of the particular Category both when they are written and when they are read.

Typically, not all Users have access to all Categories. By tailoring the scope and nature of the access of each User, the Moderator can maintain the focus of each User to only certain Categories, as well as manage security issues. A User, then, views only those pages of content that the User is allowed access to. This is administered by a profile data string that is stored in a central computer database 12, and is associated with the User through the User's login ID and/or password, or through other forms of identification as designed by the Moderator.

When a User has access to a certain Category of content or a portion thereof, he or she may view this portion of the content in the Content Area by navigating to this Category or Sub-Category. The content associated with the Category or Sub-Category is then displayed in the Content Area and the User having access to the Category or Sub-Category has access to review this content.

If the User has a new Point (as in point of view) to add concerning this Category or Sub-Category, the User may do so by scrolling down to the DiD Points Module 50 appended to the end of the Content Area 44, and entering the Point in the Points Input Window 60. Since each distinct Content Module 40 within a DiD Project has a distinct DiD Point Module appended to it, each Point added by the User will be added to the other Points previously entered in this Category or Sub-Category. Thus, by adding a Point only to other Points of that Category or Sub-Category, the DiD System places the Point in context, facilitating other Users' interpretation of the meaning and relevance of the Point. Context is also maintained in a historical sense, in that Dialogues evolve over a period of time. Contextual meaning is dependant on when a Point was made as well as where. For example, the User in FIG. 7 has access to the “Current Situation” or “Current Status” page or Category, and thus may enter or save Points pertaining to this page. The User of FIG. 11 has, for example, typed up a Point pertaining to the “Food Task Group” Category. FIG. 12 illustrates the Point once saved and currently being displayed in the Points Display Area.

Before sending the Point, the User typically selects from several possible Sub-Categories so that the User's Point may be further placed in proper more specific context and thereby amenable to further sorting and filtering by Moderators, Administrator, or other Users. Users may also choose a Group designation at this time, although the Project Administrator can reassign the Point to any other Group. The current installation shows two Groups, Restricted and General. Any number of Groups are possible.

Thus, each Point, and all versions of any associated documents, are typically tied to a particular Category or page of the Content Area 44, and is further tied to a particular Sub-Category and Group. The Group, Category and Sub-Category information is thus included as a header or appendix to the data of the Points message. This appended information instructs the DiD System on where the Point should be stored in the DiD Points Module 50 and thereby who will have access to the Point. Thus it is possible to manage precisely what information each User has access to view, from the broadest, most encompassing access to a very limited, specific bit of data-type view. FIG. 8 illustrates one embodiment of the present invention in which the “Medical Task Group” Category contains two Points designated as pertaining to two different Sub-Categories, one “General” and the other “Design.” That is, for the latter Point, either the “Design” Sub-Category radio button was selected with the Point was saved, or the Moderator subsequently re-designated the Point as pertaining to the “Design Sub-Category.

As distinguished from a standard e-mailing system, the Point does not go directly to the receiving User's computer but is routed to the DiD System and whether a particular User may ever review the Point depends on whether this User has access to the Category and Sub-Category from to the Point is associated. This keeps all communications secure and confidential behind whatever firewall of security is chosen by the Project Moderators. Similarly, the data string that represents this Point contains additional information, discussed further below, some of which may further restrict which Users, and indeed, which Moderators, may have access to the Point.

The User of FIG. 8 has access to the “Medical” Category, and sees displayed in the Points Display Area 70 two Points pertaining to this Category. The first-listed Point (i.e., the most recently saved Point within this Category), Point Number 232, is a Point pertaining to the “Design” Sub-Category and contains a suggestion for renaming the page. Only those other Users that have access to the “Medical” Category will have access to this Point. Moreover, these Users have the ability to sort according to the Sub-Category, and accordingly, only those Users that have both the proper access to the “Medical” page and the further interest in the “Design” Sub-Category will have their focus and attention diverted to the subject matter of this Point, and only once they have already turned their attention to the “Medical” page. As a result, a Point in the DiD Points System 10 is a highly directed message, causing the least, rather than the maximum, possible interruption in workload among all Users.

The primary purposes for the restriction of access in the DiD System includes to maintain the context of the Point and thereby its relevance and to manage the security of the system. Naturally, in a large project, an individual's message or point of view will be more relevant to certain members concerned with certain aspects within the project than others. In the DiD System, the Point will only be noticed by a Administrators, Moderators, and other Users who have the relevant access and only when that User turns to the particular DiD System Category or Sub-Category under which the Point was originally authored. If the User is logged onto the DiD System, but viewing another Category, presumably one of greater interest to this User at this time, the Point will not be immediately apparent, and therefore does not interrupt the User's work. It will be viewable by the User only when the User turns his or her attention to the Category or Sub-Category of the Point. Consequently, one primary purpose of this context-laden system is to facilitate focus of all Users. And that only those with access to the various Categories can view various sections of a Dialogue.

That is, in any real-world project, whether in private industry or in public entities, one User's focus will be different from another's focus, and it will be different from his or her own focus at a different time and under different circumstances. Unlike standard emailing structures, the DiD Points System 10 does not interrupt the present focus of all other Users. First, the Point is not accessible to all other Users in a project, but rather, it is accessible only to those Users within Teams that are designated as having access to the Category or Sub-Category under which the Point was authored. As a result, Users who are focused on other areas of the project, and as a result do not have access to the Category or Sub-Category, will not have their focus interrupted. Second, even a fully authorized User, one who has the access to numerous Categories and Sub-Categories, will also not have his or her focus interrupted while attending to some other Category. The DiD System will display the Point in the DiD Points Module 50 and the User will be able to read the Point only when such User turns to the Category under which the Point was authored.

Thus, in this way, a DiD System is a significant improvement over a standard e-mail type process in another aspect. In standard e-mail systems, all communications are peer to peer and are un-Moderated, which is to say they have not been put in context by a leader and thus all have about the same “weight” and require each recipient to determine the relevance of each communication.

Yet another improvement over typical e-mail systems is the historical aspect of a DiD System. While it may be possible that, at sometime later in an extended dialogue, or long after its conclusion, a member could theoretically reassemble all of his or her past e-mail messages in order to answer “what happened and why” types of questions, it is doubtful that it could actually be done in a real world scenario. Moreover, reliance on each e-mail user to maintain such complete record is impracticable, it is not a sound practice for an organization, it would be vulnerable to selective and unreliable record keeping, and would ultimately be very labor intensive and time consuming. Conversely, DiD Systems with their Project orientation and their automatic contextual saving of all relevant Points and documents overcomes each of these common problems.

When an authorized User turns to the Category “Witnesses,” he or she will view for the first time the “NEW” Points, which typically will be displayed at the top of the list of Points for that Category. Once viewed, the “NEW” symbol will be removed from those particular Points, or alternatively, the NEW demarcation will be removed only upon logging out after viewing the new Point. Any additional new Point that is entered into the system after the last log in, would now be marked NEW.

Normally, the list of Points will initially be listed in reverse chronological order. The User, however, may sort or filter the Points according to a number of other columns of information in the Points Header that have accompanied the Point. Thus, for example, a User may filter out all Points dealing with witnesses still being “sought” and instead focus on only Points dealing with witnesses already interviewed, etc. FIG. 4 illustrates a list of Points sorted alphabetically according to the last name of Author of each Point. In this embodiment, the color or brightness of the arrow indicia in Column Header 72 indicates which column of data is being used to sort the Points.

Moreover, the Moderator and/or Administrator may structure the system so that certain Points, for example ones involving subpoenaed witnesses, are viewable only to certain Teams. Additionally, the Moderator may also filter out certain Points in order to improve the efficiency and focus of the Users in his or her Team and the secure treatment of sensitive information. For example, the Moderator may also take particular notice of Points involving witness protection and label any such Points that contain sensitive information as “restricted” and thereby viewable only to those having the necessary access privileges. Raising the Priority level of a Point also allows Moderators to designate, even within specific Category/Sub-Category/Group areas of focus, a particularly relevant or current Point. Points can also be sorted by Priority.

The contextual nature of a Point insures that Users are able to quickly make sense of an Author's Point without having to manually connect the Point to a Category and Sub-Category to which the Author was referring. Therefore, this method substantially improves the efficiency of the dialogue. Where a Point is of sufficient significance to warrant the immediate attention of other authorized Users (i.e., Users having the proper access to the relevant Category), the Author may also announce the entry of the important Point by broadcasting an announcing e-mail message 33 to the authorized Users. Alternatively, a Moderator may deem a point worthy of issuing an Announcing email message. In either case, no secure information is revealed in the announcing e-mail message. If the Author or Moderator chooses to broadcast such an e-mail message, the DiD System selects as the proper recipients of the message those Users that have access to the relevant Category and/or Sub-Category and/or have been so designated by a Moderator in their User Access Privileges, and the DiD System includes in the message a hyperlink to the URL address so that each recipient can turn immediately to the Point and to the context in which the Point was authored. That is, each Category, or Sub-Category in some projects, is associated with an email address list of only those Users that have access to that Category. These relational email lists are maintained and updated by the Administrator.

When clicking the hyperlink in the message, the User will first be required, as always, to successfully complete the normal login sequence before accessing the Point to insure that only authorized Users access the system and the affected Category or Sub-Category. For example, Point Number 231 in FIG. 8 is a simulation of a real-time message alerting the Medical team that the weather pattern may delay shipment of medical supplies, but that a request for a faster weather satellite feed has been made. Such an urgent message may be accompanied by an email message 33 notifying all authorized Users that an important and urgent Point has been entered into the system, as shown in FIG. 9.

In DiD Systems that place a premium on security issues, the text contained in the email message should be cognizant of the security issues of the particular DiD Project or Category, relaying only the necessary information to prompt other authorized Users to seek out the Point in the DiD System, preferably containing a hyperlink leading the recipient directly to the Point (while, of course, requiring the recipient to successfully enter any necessary passwords or to comply with any other security precautions along the way). Consequently, in such highly secure DiD systems, the text of the email message may be automatic as predetermined by a Moderator or Administrator, just as the recipient list of the email message is automatic as predetermined according to the Category. In other less security-intensive DiD systems, after selecting the “Announce Point” option 68 in the Points Input area 60, the text of the email message may be created or freely modified by the author of the Point.

That is, where security is an emphasis, or also for purposes of causing as little disruption to as few Users as possible, email message 33 may include only that the message was sent and that the leader or other relevant Users should review it at their earliest convenience, not the substance of the urgent message. In such cases, the link saves Users from having to hunt for the new Point. They will be take directly to its location as well as context in the system. In this way, the DiD System is maintained with its emphasis on context-laden communication, while, for those occasions where interruption is preferred, a very minimal email message may accompany the submission of an urgent DiD Point to insure that the Point is reviewed quickly—in effect getting bumped up in the queue. Each Team can, of course, develop its own working methods and DiD techniques and etiquette, using a greater combination of Points entry and e-mail or text-messaging, depending on the needs of the Team.

Additionally, a new Point may refer to another already existing Point. When an Author creates a Point, the Author may also indicate one or more existing Points that the new Point is referencing. These one or more existing Points may be entered by Point Number in the Reference Area. (An automated Reference button is also included in each Point.) The system intercepts this string and converts it into one or more hyperlinks to the location of the referenced Point(s). The system then appends the hyperlink(s) to the new Point and displays the hyperlink(s) along with the new Point in the Points Display Area. As a result, when a User views the new Point and is interested in one of the referenced Points, the User needs only to click on the hyperlink for that referenced Point, and the system will move the viewer to the referenced Point. This is another way in which context, an essential ingredient of all comprehensive communications is maintained. Afterwards, the User can return to the original, new Point by clicking on a return hyperlink that is provided by the system in such an instance.

Although the present invention contemplates the possibility of referencing multiple Points by a new Point, it is envisioned that, as a general practice, a best mode of the present invention would involve only dialogs wherein only a single Point is referenced by any other Point. Referencing only a single Point facilitates one primary purpose of the present invention, namely, promoting the authoring of Points, the reading of Points, and the responding to Points in the most expeditious, contextual and efficient manner possible in a network project dialogue environment. The practice of referencing more than one Point should be done only occasionally and cautiously, just as communicating multiple issues in a single Point should be undertaken only rarely and cautiously. The title “Point” is instructive: the DiD System is best engaged when Points contain a single message and reference, at most, a single other Point, thereby reflecting the linear nature of purposeful, goal-oriented conversation.

Once the User has reviewed the referenced Point, the User can then return to the new Point by clicking the mouse button or depressing some other pre-designated key. Alternatively, in place of this method of inserting hyperlinks, the Point Numbers for the Points that are referenced by a new Point may be appended to the end of the new Point. The User may then simply sort all existing Points by Point Number, described above, and then scroll down to the referenced Point or Points.

The Author of a Point may upload a file and request that the Moderator attach the uploaded document, such as a word processor document, a spreadsheet, a JPEG or GIF file, a PowerPoint file, a video or an animated file. Several forms of file compression are also supported. This is accomplished by an “Upload a File” button in the User Controls area 52. Authors can also Upload links to other secure servers or remote files. These Uploads are viewed by the Moderator and, at the Moderator's discretion and security considerations, may be included in the Dialogue as an addition in the Content Area 44. FIG. 13 illustrates a typical window that would open when a User selects the “Upload a File” option in the User Controls area 52.

The Moderator can also include in the Dialog through the Content Area 44 a subsequent version of a file previously included. This is common when the DiD Project involves revisions of documents, such as legislation published for comment from colleagues or the public, contracts, bids or proposals, business plans or other business articles or papers, computer code, and the like. In such cases, the several iterations, or version, of the document should remain inviolate as part of the permanent, central record of the DiD Project, such as being burned into compact disc that may not be overwritten or deleted.

In one such embodiment of the present invention, an original document is proposed and made available to Members or Users of a given Category. One or more Users may choose to make edits to the original document and submit these edits as an Upload file using the “Upload a File” button in the User Controls area 52. The Moderator selects from these proposed edits a subsequent version of the original document to be made available to the other authorized Users, such as in a Category Summary, for further comments or edits. If the subsequent version is submitted by the Moderator with the same filename as the original document, the DiD system automatically renames the subsequent version according to a predetermined sequential numbering system established by the Administrator and/or Moderator.

The present invention can be configured to ensure accountability, recognition and tracking of all Users' Points and other transactions within the module, allowing management to closely monitor and respond to the various points of view raised by users. This system therefore allows for interactive dialogues at any time, from anywhere, and allows for expediting time-critical decisions and enables rapid implementation of action plans to achieve objectives. This system can manage the vast amounts of information required for corporations and governmental agencies to fulfill their tactical and strategic mandates, can create contextual, permanent, historical records of every dialogue, and improve the clarity of internal and external collaborative tasking exchanges.

In a preferred embodiment, the DiD System is based on a consistent, “lowest-common denominator” design philosophy. This is to insure rapid deployment and customization, system stability, a robust system, and a reliable system that is easy to use and has minimal User technology requirements, in which no special client software is required and minimal User training is needed. The DiD System has the ability to take full advantage of the inherent strengths of the Internet. In this preferred embodiment, the DiD Server is designed to work with any Java 2 platform, Standard Edition 1.3 runtime environment, using JDBC 2.0 for universal database connectivity, with the ability to be adapted into numerous System configurations, including ASP-type configurations. This embodiment can have security configurations to meet all needs, including operation behind firewalls/VPNs and usable with most any network Security protocols, as well as TTY-type configurations with two way information updates using a digital cell phone, a live voice TTY operator or Personal Digital Assistants

Thus, the DiD Server may employ hierarchal security clearances, authorization, access, and privileges. A Project Moderator, typically aided by an Administrator, controls the creation of, and assignment of Users to, necessary Teams. The nature of each User's access to portions of the system is defined by this assignment, which in turn defines any needed levels of security, authentication and authorization. Each User has designated privileges, and only an authorized Moderator or Administrator can change Team assignments and other aspects of authentication and authorization. Users can change their own passwords, but their access parameters remains as assigned by the Moderator/Administrator.

All authorized users are simultaneously or individually allowed access to the most current iteration of a project's essential elements, promoting the free flow of ideas within a structured, hierarchal, consensus-building environment that facilitates critical decision-making, and provides a central coordination and preservation for all communications and related data. All authorized Users are always “in sync” with the latest information, files, summaries and directives, as well as all “points-of-view” viable from within their Categories. All needed decisions, debates and data is stored, or referenced, within a DiD System, including for example versions and markups of an evolving text, such as specific legislation, contracts, visuals or manuscripts. Use of DiD eliminates miscommunications due to confusion regarding which form of communication is in use to manage and develop a project, (i.e. phone, fax, email, printed documents, live exchanges, etc.) and are quickly applicable to improve management of any number of dynamic, open-ended, time-critical situations. This includes, but is not limited to, corporate and/or government project management and development, legislative and regulatory markup, customer service management, developing websites, presentations, reports and other creative projects, fast-breaking emergencies, criminal investigations, complex legal work, group sales efforts, motion picture, television, industrial video, development and production, and event planning, investment management and summaries, customer service, database compilation, etc.

Examples of possible types of DiD access arrangements include highly secure, technologically elite, confidential groups (such as Governmental agencies, law Enforcement, and discreet business groups) on one hand, and open, public, deliberations involving large numbers of participants with the lowest levels of computer technology and training, on the other (such as regulation markup, legislative creation and review, public input to corporate initiatives). In each of these examples, a DiD System is capable of managing the vast amounts of information needed to fulfill the strategic and tactical mandates of industry and government agencies. DiD Systems allow for more interactive Dialogues at anytime and from anywhere, provide superior Information management and retrieval tools, and improve the quality of internal and external collaborative tasking interactions.

Clients can include individual, group, school- or community-wide educational activities, entities and associations involved in the fashioning of regulations or legislation by lawmakers, lobbyists, experts and constituents, research projects and invention development, management and analysis of complex medical cases and consultation, managing hazardous materials cleanups, coordinating all parties of construction projects, managing the development of business deals and negotiations, project requests for bids, quotes or proposals and vendor presentations and responses thereto, etc.

DiD Moderators can create DiD installations which mirror existing Teams and organizational structures, including establishing Teams or Categories that match existing department structures. Through DiD, Moderators can break down large projects into more manageable Categories and Sub-Categories, Control a potentially chaotic flow of ideas, Receive a continual interactive inflow of new documents and ideas, and maintain a central point from which to “marshal the troops.” Through DiD Systems, DiD Moderators can manage any size response and can quickly assemble Teams and communicate announcements. This results in saving money and time otherwise spent in meetings, as well as reducing travel costs, and saving time and confusion associated with miscommunications. If Teams maintain DiD “discipline” and use the system consistently, there is no voicemail, facsimiles, e-mail messages, or spoken instructions, which cause gaps in the record, confusion and deniability. With the DiD System, every Point and counter-Point and all versions of all documents are historical and maintained inviolate once entered into a system by being burned into compact disc or other such permanent record keeping.

Through the DiD System, DiD Team Members and Users are encouraged to supply creative input, always have one place to present their point-of-view and to receive feedback, and always have one place to receive management summaries and directives and always have one place to share and receive versions of related documents in a secure environment. Users can reach all other Users and levels of management from one forum. Particularly beneficial to Members that are geographically remote from the DiD Moderator, socially shy but insightful Members, and to any other particularly busy Members. Additionally, it facilitates the communication of useful but unpopular comments. It also assures that Members are always notified of important events and updates.

Senior management, who can be too busy to consistently “stay in the loop” otherwise, can more simply oversee the dialogue occurring in any given Team that concerns him or her. He or she can quickly discover what all levels of people are really thinking, what is and is not being done, and how well Moderators are functioning. If the Team is not displaying the abilities needed to succeed, the senior management can step in and quickly identify or communicate with the appropriate people, using contextual leadership, information sharing or queries.

DiD Systems also create a historical record of the collaborative project. Once submitted, DiD Points are saved and permanently retained in their original context. That is, each Point text is stored in a field within a record of a database. Each record also retains information describing when and where the Point text was entered, by whom, and what it relates to. This guarantees the integrity of all dialogues, and the historical record remains complete and chronological. All comments representing all points-of-view presented in any ongoing and evolving Team deliberations then are available to be searched and reviewed (either currently or later). The same is true of all versions of all related documents, as well as all Category Summaries.

Once saved, the text of an individual Point cannot be modified. Any desired corrections, updates, etc. can only be addressed by submitting a new Point, with the new information. Text may be entered in the Points Input Box 60. Photos, graphics, videos, animations, spreadsheets, audio files, QuickTime Virtual Reality Scenes, PowerPoint Presentations, etc. can be referenced and uploaded to the Dialogue. These files will be included in or not at the leaders discretion. Transfer of other types of files is supported, and such entries are as secure as the ongoing DiD System. Virtually all file types are supported.

The DiD system thus can track senders, Users, etc. Users can initially assign a Sub-Category and Group to their Point. Uploaded documents are stored with automated offsite and onsite back-up controls available. A Point can reference other Points. The Administrator can link or attach any file to the Content Area, so that it will be displayed to Users. The Administrative Area allows Administrators/Moderators to view a listing of all Attachments and a preview of all images. Other Administrative areas allow for the tracking and reporting of the great wealth of information continually collected and stored, which documents all activities which take place within a system.

Points can be reassigned to a different Sub-Category by the Administrator, if deemed appropriate. If a Point's Sub-Category is reassigned, a new Point is automatically, simultaneously generated, in the original context, to indicate the shift. Continuity is thereby preserved, and mismanagement is discouraged. Normally, the Point's author is notified of the reassignment. At the discretion of the Administrator, a Point's Group assignment can be changed without notice for good cause. Priority levels can also be changed by Moderators to indicate their belief as to the current importance of various Points.

All Points remain readily accessible, depending only on the access privileges to specific areas of content and other authorization specifics associated with an individual User. All Points can be sorted and filtered in the Current View settings for that User. These controls allow Users to simply click on any column header to sort all revealed Points by the columns content, as described above. Ascending and descending sort orders are supported. Advanced, multiple criteria sorts are possible. The sorting function is controlled in the User Controls area.

The Points Number is automatically generated by the DiD server and is attached to the Point. In one embodiment, each Category has its own set of Points numbers. Alternatively, all Points are numbered sequentially, regardless of the Category. In either case, Points can be viewed only within their respective Categories and only by properly authorized Users.

In addition to the Point Number, all Points are labeled with several other indicia, which are displayed in columns, and which provide other options for sorting Points. A Sub-Category Indicator is selected by User when saving a Point, and can be modified at a Team Moderator's direction. The Sub-Category Indicator is important explanatory data which maintains continuity and integrity of the dialogue, and adds specific context for the Point.

The Group Indicator shows who is able to view the Point. This indicator may be set by the User when saving a Point, and can be modified without notice at Moderators direction. The Author Indicator is automatically generated by DiD server and identifies the User that authored the Point. This indicator is derived from the User security and access information gained at the point of the User's entry.

The Time and Date Indicator is also automatically generated by the Host server, marking the moment a Point is received. Time is set by a predetermined time preference, such as Greenwich mean time or other universal time (especially useful if Users are geographically remote covering several different time zones). Alternatively, the Time could be preset as the Host's local time with an indication of such.

The Priority Level may be chosen by the Moderator using the Priority Indicator feature 63, which may be set up as a Category or Project Control. The Priority Level is useful for better managing large numbers of submitted Points in a timely and efficient manner, and for prioritizing responses thereto. Typically, a Moderator ranks new Points on a scale from those most urgently in need of a response to those which seem to be less pressing. Old Points can be redesignated a higher or lower priority based on changed circumstances or the approach of an impending deadline.

The Status Icon indicates each Points current status and allow management and Users to quickly track the progress of a Point throughout its processing. Definitions for the Status Icons are adapted by management, depending on circumstances. Rolling over any Status Icon will cause a definitions “drop down” to appear in the Users Controls area. A Status Icon Key is also provided in the User Controls area.

The DiD System keeps a permanent record of all Users log-in/out actions and all IP addresses used to access a DiD System, and thereby ensure tracking, accountability and recognition of all Users. When DiD Team discipline is maintained, and all pertinent activities take place within a DiD, all Points are always “on the record.” As a result, in addition to improving accountability, the DiD System ensures proper recognition of the source of all ideas and a record of the quantity of effort expended by each User to advance a DiD System.

The DiD System also improves connectedness of senior management since the content of ongoing DiD Systems can also be monitored directly by senior management, at any time convenient to the senior manager, even after a DiD System has reached a conclusion. That is, management can quickly and easily “peer down” into the hierarchy and better supervise the content, quality, direction, etc. of all company activities conducted within any number of DiD Systems. Or historically review, analysis, critique, defend, etc. the results of a Dialogue. This can also be useful for organizational memory, training and for any legal issues which may arise.

At the same time, lower level Users are restricted to Points raised and documents generated within their Teams, and further only to those Points not hidden, and documents presented by the Moderator. Thus, whereas the System improves the ease of access to information for management, the same System provides more restrictive levels of access for lower level Users, all of which may be controlled by management. This not only maintains security, but also maintains focus of the lower level Users and reinforces existing corporate structures.

The DiD System also facilitate the process of announcing and responding to changes by Users and by Management. The System includes Team-wide alerts that can be sent to Users and Management when a new Point has been saved within the secure environment. No secure data need be included in these announcements, and thus, the security of the DiD System is maintained. Additionally, a User can set up a separate “changes” section within the interface that is displayed when he or she logs-in, in which all unreviewed changes are listed, or the NEW feature and date/time sorting capabilities can be used to identify these “changes.” As a result of this automatic notice feature, Users and management can engage in other activities, confident they will always be aware of all important Dialogue changes when they happen.

The DiD System also aids management in concluding a project. DiD announcement Tools can also be used to announce the termination of a DiD Project, distribute final conclusions suitable for public viewing, and distribute congratulations or other appropriate reviews. In secure applications, the DiD System may also be used to announce sensitive conclusions which remain within the secure DiD environment.

DiD Systems therefore contain multiple controls for all Users. Administrative controls include adding and editing Users, defining Categories, defining and notifying Teams, controlling Dialogues, creating and editing Categories and Sub-Categories, reassigning Points Sub-Categories, Status, Groups and Priorities, and uploading files and making files available for downloads. Administrators also can set up the Status Icons, including defining the types of icons and their graphic appearances, defining the properties of each, such as on or off, completed or not completed, active or inactive. Administrators also have many Reports available for their use. These include access, use, uploads, downloads, and a record of any editing done to all content and Points.

The Project and/or Category Moderator/Administrators also set up and manage the Announcements Area. He or she can select one of several possible configurations, such as a single announcement, a rotating announcements, timed announcements, links to multiple announces, or the like. The Administrator, under the direction of the Moderator, manages the actual content of Announcements, including determining the particular text is included, how often rotating Announcements change, the timing for any “time released” Announcements, and any appropriate links to other areas within or outside of the DiD installation. The Administrator can also set up and manage the Help files describing all Module parts and functions and set up and manage the General User Preferences.

The User Preferences can be either global and Category-specific, or a combination of both. Certain default preferences, such as the Group security level setting and the Sub-Category settings, are established by the Administrator. Preferences may include multiple advanced sort options and may be used to limit the Points that may be viewed according to the Status, Team, Priority level, Author, time frame, or any combination of these Points attributes.

The “Upload a File” option in the User Controls allows the User to select one or more files to be uploaded and optionally referenced in a Point. The Upload file is maintained inviolate by the DiD system, as described above. Once a file is uploaded, the User is automatically taken to the Points Input area 60. A notice indicating the receipt of the file is displayed, and an automatic sentence is added to the Points Input area 60 indicating the name of the Uploaded file. This automatically generated Point may be added to, edited and saved, at the User's discretion. Although not advisable, the automatic Point may also be deleted by the User instead of saved. Proper DiD practice would encourage the entry and saving of the Point to better document the Uploading of the file.

If an Author of a new Point wishes to Reference an existing Point he or she is viewing he or she may click on the “Reference this Point Button.” This automatically enters the existing Point's Point Number to the “In Reference to Point” Input box 67 and moves the Author's cursor directly to the Points Input area.

Another benefit of the DiD System is that it reveals and records an organization's processes of conducting their business. This is useful for organizational memory and knowledge management needs. Management can review and monitor DiD Projects to evaluate the actual inner workings of Teams. Additionally, it allows replacement workers to review how real-world, work projects were handled by reviewing archived DiD Projects, and it further aids in training replacements to learn a position's responsibilities and functions by monitoring a DiD Project, as it progresses. It allows for operational “post mortems” by management or others, and can aid in legal disputes regarding organizations activities.

Equally as important is the fixed nature of Points and Upload files once they are submitted. Once a Point or Upload file is submitted, it is maintained inviolate. It cannot be altered or deleted. Instead, the Point remains existent throughout the project and afterward. This is another great improvement over standard email practices. As a result, at anytime, even long after a project is completed, a Moderator or Administrator can look back to see exactly who made what Point and exactly what the Point was at the time. Moderators can use this “history” to determine which Teams are current and which are behind in meeting their deadlines, and which Users are doing the more fruitful work. New Users can use this “history” to quickly determine the evolution of a project and all its constituent parts and how to contribute to the DiD Project. Additionally, the Category context and Sub-Category, Status, etc. info that is appended to each Point aid in the sorting and filtering during each of these uses of and researching into the history of the Points and documents previously submitted and pertaining to the particular Category. The inviolate nature of Points and versions of documents also assures all Users that they are involved in an uncensored dialogue.

Items below in brackets “[ ]” are standard database field types. “Char” is a field that holds general characters. “Long” is a field for decimal numbers. “dateTime” is a field that stores both that date and time in a single item. The term “unique” denotes that the entry in that field must be unique within the said database table. The term “key” denotes that said field will be used as a key when relating to other tables. “Boolean” is a field that can be true or false only. Thus, a preferred embodiment of the present invention utilizes several DiD Points Module databases, each database corresponding to a different Category, as illustrated in FIG. 6. Each Category comprises a categoryID [char, unique, key], a Title [char], a shortCode [char, 4], Sub-Categories [char], a Group [char], an Announcement, and URL/URI [char]. The Announcement is further divided into a Group ID, an announcementID, an announcement[long], and an announcementDateTime [dateTime].

Another database is the database of Points. Each Point comprises a Point Number or pointID [char, unique, key], a PointText [long], a Status [char], an active/Inactive [Boolean], a categoryID [char] (identifying which Category does this belong to), a Sub-Category [char], a Group [char], a dateTime [dateTime], an Author [char], a TrackingIP [char] (IP used to enter note), a Source [char] (Web, PDA, SMS etc.), one or more References to other Points [char] (identifying the other Point(s)' Number), and a Priority [char]. (Documents Upload and Download database.)

Another database of one embodiment of the present invention and the Users database. Each User entry in the Users database comprises a FirstName [char], a LastName [char], a Network address [char], an AccessIP [char] (If restricted), a LastAccess [dateTime], a LastIP (IP address), a LastCategoryAccessed [char] (categoryID), a Password [char], one or more Categories [char], a userID [char, unique, key], a DefaultGroup [char], a DefaultFilter [char], a DefaultSort [char], and a DefaultMisc1 [char].

Additionally, associated with each User is a User Category Preferences database, comprising a userID [char, unique], a categoryID [char], a DefaultSubCategory [char], a DefaultGroup [char], a LastSort [char], a DefaultSort [char], a LastFilter [char], a DefaultFilter [char], a LastRevealShow [char] (min Priority to show), a LastRevealPreview [char] (min Priority to Preview), a DefaultRevealShow [char], a DefaultRevealPreview [char], a LastMisc1 [char], and a DefaultMisc1 [char].

The DiD System also comprises a Sub-Categories database. Each Sub-Category entry comprises a Name [char, unique], a subCategoryID [char, unique, key], a bgcolor [char], a textColor [char], and a Description [char].

Additionally, there is a database of Status Levels. Each Status Level comprises a unique icon [char](or more accurately an address or URL for locating the icon image within the network), a shortName [char, unique], a longDescription [long], and an active/Inactive [Boolean].

The system also comprises a Categories database. Each Group entry comprises a groupName [char], a groupID [char, Unique, key], and a groupDescription [char]. Also there is typically a FileControl database. Each File Control entry comprises a categoryID [char], a shortTitle [char], a URL [char], a dateTime [dateTime], a userID [char], a Version [floating], a Group [char], and an assetID [char, unique, key].

As is contemplated by the present invention, a User with a sufficient level of security access could filter the Points according to Sub-Category, dateTime or a range thereof (e.g., Exact, Before, After, Within, Since Last Visit), Group, Status, Creator, Priority, pointID (range, exact), active/Inactive (Boolean), PointContent, or PointReferences.

Likewise, in one embodiment of the present invention, a User having sufficient security level access could sort (individually or combination with priority) according to Sub-Category, dateTime, Status, Creator, Priority, pointed, activeInactive (Boolean), or any of the filters listed above.

While the present invention has been described with regards to particular embodiments, it is recognized that additional variations of the present invention may be devised without departing from the inventive concept.

What is claimed is:

1. A system for facilitating the exchange of information between users of a computer network to accomplish a project, comprising:
a. an administrator,
b. one or more moderators,
c. at least one team of users,
wherein each user has access to a central computer through a communication device having a screen display comprising a content module and a points module, said content module comprising an upper content area and a content area, and said points module comprising an announcements area, a user controls area, a points input area, and a points display area,
wherein said content area displays one page of content corresponding to a category within said project and is controlled by said administrator or one of said moderators, wherein said announcements area displays information corresponding to said category and is controlled by said administrator or one of said moderators, and
wherein said points display area displays one or more points corresponding to said category, and wherein the contents of each of said points is maintained inviolate and unalterable.

2. A system according to claim 1 wherein each of said points is designated as corresponding to a particular category as a result of its being saved when said page of content corresponding to said particular category is being displayed on said screen display.

3. A system according to claim 2 further comprising a second team of users who are authorized to access a category distinct from said particular category, but not authorized to access said particular category.

4. A system according to claim 1 wherein each of said points comprises an identifier indicating the author of said point, a creation date and time stamp, and an identifier indicating the category being displayed on said computer screen display when the point was saved.

5. A system according to claim 4 wherein each of said points further comprises an identifier indicating a sub-category, an identifier indicating a group, and an identifier indicating a priority of said point to facilitate sorting and filtering of said one or more displayed points.

6. A system according to claim 5 wherein at least one of said points further comprises a reference number indicating at least one other point.

7. A system according to claim 1 wherein said points input area comprises a plurality of sub-category buttons, a plurality of group buttons, a points entry box, a reference points entry box, a point announcement option, and a save points button.

8. A system for facilitating the exchange of information between users of a computer network for accomplishing a project, comprising:
a. at least one team of users,
b. a plurality of categories corresponding to topics within said project,
c. a moderator for each of said plurality of categories,
d. a central computer containing software and data for the display of a plurality of content pages each corresponding to one of said plurality of categories, and
e. means for selecting among said plurality of content pages according to access authorization data corresponding to a user identification and password for a user
wherein each content page has appended thereto a points module comprising a points input area and a points display area,
wherein users can freely submit points and view points from other users having similar access authorization, and
wherein users can freely submit upload files, but can only download files distributed by a moderator.

9. A system according to claim 8 wherein each of said submitted points is maintained inviolate and may not be altered by any other user or by said moderator.

10. A system according to claim 8 wherein at least one of said plurality of content pages contains a complete history of all versions of distributed upload files and wherein each said version is held inviolate and cannot be overwritten.

11. A system according to claim 8 wherein said points module further comprises an announcements area displaying information selected by said moderator for said category.

12. A system according to claim 8 further comprising a predetermined hierarchy to permit at least one of said moderators to access all content pages and all points, and to permit each of said users access to only predetermined content pages and to only points corresponding to said predetermined content pages.

13. A system according to claim 8 wherein each of said points further comprises an identifier indicating a sub-category selected at least initially by the author, an identifier indicating a group, and an identifier indicating a priority of said point for classification purposes.

14. A system according to claim 13 wherein at least one of said points further comprises a reference number of at least one other point.

15. A system for facilitating the exchange of information between users of a computer network comprising:
a. at least one moderator,
b. a plurality of users,
c. a central computer, and
d. a plurality of computer terminals each in communication with said central computer and having a computer screen display comprising a content module having a content area, and a points module having a points input area, a points display area, and one or more user controls,
wherein said users may submit points through said points entry area of said points module and may submit upload files through one or more of said user controls,
wherein said points are automatically displayed in the points display area and distributed to other users having access to said points module, and wherein said upload files are distributed only upon the sole discretion of one of said at least one moderator and are displayed in the content area only upon the sole discretion of one of said at least one moderator.

16. A system according to claim 15 wherein one or more announcements are created and displayed in an announcements area in said points module only upon the sole discretion of one of said at least one moderator.

17. A system according to claim 15 wherein each of said points and each of said upload files is maintained inviolate and unalterable, and wherein each of said points is displayed on said computer screen only when a corresponding one of said plurality of categories is displayed in said content area.

18. A method for organizing and sharing information over a computer network, comprising the steps of
a. establishing at a remote communication with a central computer having data for the display of one or more pages of content on a screen display at said remote location,
b. receiving one page of said data based on access to said page of said data according to a login identifier and password of a user,
c. receiving a point submitted by another user corresponding to said page of said data,
d. submitting a new point corresponding to said page of data,
e. automatically appending author information, date and time of authorship information, and category information to said submitted new point, and
f. maintaining the contents of said point inviolate and unalterable.

19. The method of claim 18 wherein the step of submitting a point further comprises an express reference to another point previously submitted or received.

20. The method of claim 18 wherein said one page of said data is exclusively authored by a user designated as an administrator or as a moderator.

21. The method of claim 18 wherein said step of receiving points may be limited according to said login identifier and password of said user.
